(19) United States
(12) Patent Application Publication
(10) Pub. No.: US 2012/0075296 A1
(43) Pub. Date: Mar. 29, 2012

(54) System and Method for Constructing a 3D Scene Model From an Image

(75) Inventors: Eliot Leonard Wegbreit, Palo Alto, CA (US); Gregory D. Hager, Baltimore, MD (US)

(73) Assignee: STRIDER LABS, INC., Palo Alto, CA (US)

(21) Appl. No.: 13/310,672

(22) Filed: Dec. 2, 2011

Related U.S. Application Data
(63) Continuation-in-part of application No. 12/287,315, filed on Oct. 8, 2008.

(51) Int. Cl. G06T 15/00

(52) U.S. Cl. 345/419

(57) ABSTRACT

A method for constructing one or more 3D scene models comprising 3D objects and representing a scene, based upon a prior 3D scene model and a model of scene changes, is described. The method comprises the steps of acquiring an image of the scene; initializing the computed 3D scene model to the prior 3D scene model; and modifying the computed 3D scene model to be consistent with the image, possibly constructing and modifying alternative 3D scene models. In some embodiments, a single 3D scene model is chosen and is the result; in other embodiments, the result is a set of 3D scene models. In some embodiments, a set of possible prior scene models is considered.

This application is a continuation-in-part of U.S. patent application Ser. No. 12/287,315, filed Oct. 8, 2008, entitled “System and Method for Constructing a 3D Scene Model from an Image.”

### FIELD OF THE INVENTION

The present invention relates generally to computer vision and, more particularly, to constructing a 3D scene model from an image of a scene.

### BACKGROUND OF THE INVENTION

Various techniques can be used to obtain an image of a scene. The image may be intensity information in one or more spectral bands, range information, or a combination of thereof. The image data may be used directly, or features may be extracted from the image. From such an image or extracted features, it is useful to compute the full 3D model of the scene. One need for this is in robotic applications where the full 3D scene model is required for path planning, grasping, and other manipulation. In such applications, it is also useful to know which parts of the scene correspond to separate objects that can be moved independently of other objects. Other applications have similar requirements for obtaining a full 3D scene model that includes segmentation into separate parts.

Computing the full 3D scene model from an image of a scene, including segmentation into parts, is referred to here as “constructing a 3D scene model” or alternatively “parsing a scene”. There are many difficult problems in doing this. Two of these are: (1) identifying which parts of the image correspond to separate objects; and (2) identifying or maintaining the identity of objects that are moved or occluded.

Previously, there has been no entirely satisfactory method for reliably constructing a 3D scene model, in spite of considerable research. Several technical papers provide surveys of a vast body of prior work in the area. One is such survey is Paul J. Best and Ramesh C. Jain, “Three-dimensional object recognition”, Computing Surveys, 17(1), pp 75-145, 1985. Another is Roland T. Chin and Charles R. Dyer, “Model-based recognition in robot vision”, ACM Computing Surveys, 18(1), pp 67-108, 1986. Another is Farshid Arman and J. K. Aggarwal, “Model-based object recognition in dense-range images—a review”, ACM Computing Surveys, 25(1), pp 5-43, 1993. Another is Richard J. Campbell and Patrick J. Flynn, “A survey of free-form object representation and recognition techniques”, Computer Vision and Image Understanding, 81(2), pp 166-210, 2001.

None of the prior work solves the problem of constructing a 3D scene model reliably, particularly when the scene is cluttered and there is significant occlusion. Hence, there is a need for a system and method able to do this.

U.S. patent application Ser. No. 12/287,315, filed Oct. 8, 2008, entitled “System and Method for Constructing a 3D Scene Model from an Image,” discloses a system and method for so doing. The present application is a continuation-in-part of that application.

### SUMMARY OF THE INVENTION

The present application describes a method for constructing one or more 3D scene models comprising 3D objects and representing a scene, based upon a prior 3D scene model, and a model of scene changes. In one embodiment, the method comprises the steps of acquiring an image of the scene; initializing the computed 3D scene model to the prior 3D scene model; and modifying the computed 3D scene model to be consistent with the image, possibly constructing and modifying alternative 3D scene models. The step of modifying the computed 3D scene models consists of the sub-steps of (1) comparing data of the image with objects of the 3D scene models, resulting in differences between the value of the image data and the corresponding value of the scene model, in associated data, and in unassociated data; (2) using these results to detect objects in the prior 3D scene models that are inconsistent with the image and removing the inconsistent objects from the 3D scene models; and (3) using the unassociated data to compute new objects that are not in the 3D scene model and adding the new objects to the 3D scene models. In some embodiments, a single 3D scene model is chosen and is the result; in other embodiments, the result is a set of 3D scene models. In some embodiments, a set of possible prior scene models is considered.

Another embodiment provides a system for constructing a 3D scene model, comprising one or more computers or other computational devices configured to perform the steps of the various methods. The system may also include one or more cameras for obtaining an image of the scene, and one or more memories or other means of storing data for holding the prior 3D scene model and/or the constructed 3D scene model.

Still another embodiment provides a computer-readable medium having embodied thereon program instructions for performing the steps of the various methods described herein.

### BRIEF DESCRIPTION OF DRAWINGS

In the attached drawings:

FIG. 1 illustrates the principle operations and data elements used in constructing one or more 3D scene models from an image of a scene according to one embodiment.

### DETAILED DESCRIPTION OF THE INVENTION

### Introduction

The present application relates to a method for constructing a 3D scene model from an image. One of the embodiments described in the present application includes the use of a prior 3D scene model to provide additional information. The prior 3D scene model may be obtained in a variety of ways. It can be the result of previous observations, as when observing a scene over time. It can come from a record of how that portion of the world was arranged as last seen, e.g. as when a mobile robot returns to a location for which it has previously constructed a 3D scene model. Alternatively, it can come from a database of knowledge about how portions of the world are typically arranged. Changes from the prior 3D scene model to the new 3D scene model are regarded as a dynamic system and are described by a model of scene changes. Each object in the prior 3D scene model corresponds to a physical object in the prior physical scene.

In one embodiment, the method detects when physical objects in the prior scene are absent from the new scene by finding objects in the scene model inconsistent with the image data. The method takes into account the fact that an object that was in the prior 3D scene model may not appear in the image either because it is absent from the new physical scene or because it is occluded by a new or moved object. The method also detects when new physical objects have been added to the scene by finding image data that does not correspond to the 3D scene model. The method constructs new objects corresponding to such image data and adds them to the 3D scene model.

Given a prior 3D scene model, an image, and a model of scene changes, one embodiment computes one or more new 3D scene models that are consistent with the image and the model of scene changes.

It is convenient to describe the embodiments in the following order: (1) definitions and notation, (2) principles of the invention, (3) some examples, (4) a first embodiment, and (5) various alternative embodiments. Choosing among the embodiments will be based in part upon the desired application.

### Definitions and Notation

An image I is an array of pixels, each pixel q having a location and the value at that location. An image is acquired from an observer pose, γ, which specifies location and orientation of the observer. The image value may be range (distance from the observer), or intensity (possibly in multiple spectral bands), or both. The value of the image at pixel q in image I is denoted by ImageValue(q, I).

From an image, a set of image features may be optionally computed. A feature f has a location and supporting data computed from the pixel values around that location. The pixel values used to compute a feature may be range or intensity or both. Various types of features and methods for computing them have been described in technical papers such as David G. Lowe, “Distinctive image features from scale-invariant keypoints”, International Journal of Computer Vision, Vol. 60, No. 2, pp. 91-110, 2004. Also, Mikolajczyk, K. Schmid, C, “A Performance Evaluation of Local Descriptors”, IEEE Transactions on Pattern Analysis and Machine Intelligence, Vol. 27; No. 10, pages 1615-1630, 2005. Also F. Rothganger and Svetlana Lazebnik and Cordelia Schmid and Jean Ponce, “Object modeling and recognition using local affine-invariant image descriptors and multi-view spatial constraints”, International Journal of Computer Vision, Vol. 66, No. 3, 2006. Additionally, techniques are described in U.S. patent application Ser. No. 11/452,815 by the present inventors, which is incorporated herein by reference. The value of feature fin image I is denoted by ImageValue(f, I).

An image datum may be either a pixel or a feature. Features can be any of a variety of feature types. Pixels and features may be mixed; for example, the image data might be the range component of the image pixels and features from one or more feature types. In general, ImageValue(r, I) is the value of image datum r in image I.

The image corresponds to an underlying physical scene. Where it is necessary to refer to the physical entitles, the terms physical scene and physical object are used.

A scene model G is a collection of objects {gᵢ} used to model the physical scene. An object g has a unique label, which never changes, that establishes its identity. It has a pose in the scene (position and orientation), which may be changed if the object is moved; the result of changing the pose of object g to an new pose n is denoted by ChangePose(g, π). An object has a closed surface in space (described parametrically or by some other means such as a polymesh). Objects in a scene model are free from collision; i.e. their closed surfaces may touch but do not interpenetrate.

A scene model G is used herein either as a set or a sequence of objects, whichever is more convenient in context. When G is used as a sequence, G[k] denotes the k^{th} element of G, while G[m:n] denotes the m^{th} through n^{th} elements of G, inclusive. G.first denotes the first element, while G.rest denotes all the others. The notation G_{A}+G_{B} is used to denote the sequence obtained by concatenating G_{B} to the end of G_{A}.

Given an observer pose y, synthetic rendering is used to compute how the scene model G would appear to the observer. For each object, the synthetic rendering includes a range value corresponding to each pixel location in the image. If an image pixel has an intensity value, the synthetic rendering may also compute the intensity value at each point on the object's surface that projects to a pixel, where the intensity values are in the same spectral bands as the image. If image features are computed, a set of corresponding model features are also computed.

The synthetic rendering of the range value is denoted by the Z-Buffering operation ZBuffer(G, γ). In some of the present embodiments, the observer pose is taken as fixed, and the Z-buffering operator is written ZBuffer(G).

If location u is in the map of ZBuffer(G), the value of ZBuffer(G) at location u is written ZBufferᵤ(G). If u is not in the map of ZBuffer(.), the value ZBufferᵤ(.) is a unique large number, larger than any value of ZBuffer_{u′}(.) for locations u′ in the map.

Given two objects g₁ and g₂ in G, g₁ occludes g₂ if there is some location u such that

ZBufferᵤ({g₁})<ZBufferᵤ({g₂}) (1)

The projection of an object g in a scene model G is the set of image locations u at which is it visible under the occlusions of the other objects in the scene model. That is

Proj(g,G)={u|ZBufferᵤ(G)=ZBufferᵤ({g})} (2)

As a shorthand, this is frequently denoted by I_{g}. Proj(g, G) is frequently treated as the set of data whose location is in Proj(g, G), that is, pixels or features or both.

The set of data values in Proj(g, G) is denoted by lmageValues(I, g, G), defined as

ImageValues(I,g,G)={ImageValue(r,I)|r∈Proj(g,G)} (3)

The value of the scene model G at the location of datum r, computed by synthetic rendering, is denoted by ModelValue(r, G). DataError(r, I, G) is the difference between the value of the image datum at r and the corresponding value of the scene model. In various embodiments, all the components of r may be used or only certain components, e.g. range, may be used.

The prior scene model is denoted by G⁻. The scene model is changed by one of the following operations: Remove some g∈G⁻, Add some g∉G⁻, and Move some g∈G⁻ to a new pose. The resulting posterior scene model is denoted by G⁺.

The model of scene changes, expresses the probabilities of these changes. Where the scene changes for objects are taken as independent, the probabilities of these changes are written as P(Keep(g)|G⁻), P(Remove(g)|G⁻), P(Add(g)|G⁻), and P(Move(g, τ_{new})|G⁻) where π_{new} is the new pose of g. More complex models may express various sorts of change dependencies.

It is convenient to adopt the convention that every datum in the image is under the projection of some unique g in every prior and posterior scene model. This can be arranged by having a constant background object in every prior and posterior scene model. For the background object g_{B}, P(Keep(g_{B})|G⁻)=1; P(Remove(g_{B})|G⁻)=0; and P(Move(g_{B}, π_{new})|G⁻)=0.

Summary of Notation

I an image
q a pixel
f a feature
r an image datum, either a pixel or a feature
u the location of an image datum
ImageValue(r, I) the value of datum r in image I
G a scene model
G[k] the k^{th} object of G
G[m:n] the m^{th} through n^{th} objects of G, inclusive.
G⁻, G⁺ prior and posterior scene models
g an object
Proj(g, G) locations or image data to which g projects in G
Model Value(r, G) the value of model G at the location of datum r
DataError(r, I, G) the error at the location of datum r

### PRINCIPLES OF THE INVENTION

Given a prior 3D scene model, a model of scene changes, and an image, the described method computes one or more posterior 3D scene models that are consistent with the image and probable changes to the scene model.

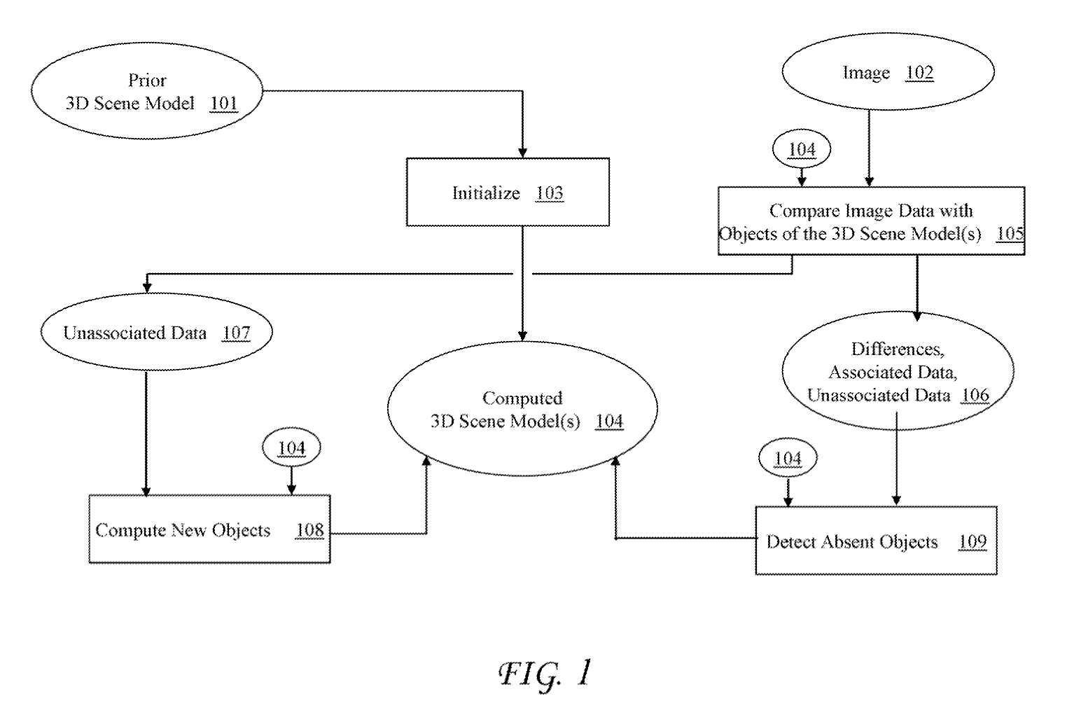

In broad outline, one embodiment operates as shown in FIG. 1. Operations are shown as rectangles; data elements are shown as ovals. The method takes as input a prior 3D scene model 101 and an image 102, initializes the computed 3D scene model(s) 104 to the prior 3D scene model at 103, and then iteratively modifies the computed scene model(s) as follows. Data of the image is compared with objects of the computed scene model(s) at 105, resulting in differences, in associated data 106, and in unassociated data 107. The objects of the prior 3D scene model(s) are processed; the results of the comparison are used to detect prior objects that are inconsistent with the image at 109; and these inconsistent objects are removed from the computed 3D scene model(s). Where it cannot be determined whether an object should be removed or not, two alternative computed scene models are constructed: one with and one without the object. From the unassociated data, new objects are computed at 108 and added to the computed scene model(s). The probabilities of the computed scene models are evaluated and the scene model with the highest probability is chosen. In various embodiments, the data may be either pixels or features, as described below.

In some embodiments, a set of posterior 3D scene models may be returned as the result. The prior scene model may be the result of the present method applied at an earlier time, or it may be the result of a prediction based on expected behavior, e.g. a manipulation action, or it may be obtained in some other way. In some embodiments, a set of possible prior scene models may be considered.

### The Objective Function

Consistency with the image and probable changes to the scene are measured by an objective function. An image I, a prior scene model G⁻, and a model of scene changes are given. A posterior scene model G⁺ is optimal if it maximizes an objective function

ObjFn(I,G⁺,G⁻)=P(I|G⁺)P(G⁺|G⁻) (5)

The first factor is the probability of I given G⁺ and is referred to as the data factor; the second factor is the probability of G⁺ given G⁻ and is referred to as the scene change factor. The present method computes one or more posterior scene models G⁺ that such that the value of the objective function is optimal or near optimal.

In this computation, the image I and the prior scene model G⁻ are fixed. Hence, it is convenient to refer to equation (5) as computing the probability of the posterior scene model G⁺.

It is usually computationally advantageous to work with the negative log of the probabilities, which can be interpreted as costs. Instead of maximizing the probabilities, the optimal solution has minimal cost. That is, the ideal posterior scene model G⁺ minimizes

ObjFn2(I,G⁺,G⁻)=−log P(I|G⁺)−log P(G⁺|G) (6)

For the purpose of simplicity in exposition, the probability formulation is used below with the understanding that the cost formulation is usually preferable for computational purposes.

Where scene changes are independent, equation (5) can be rewritten by multiplying over the objects in G⁺ and G⁻. Let g be an element of G⁺. It may also be an element of G⁻. In this case, it may have the same pose in G⁻ as in G⁺; this is denoted by the predicate SamePose(g, G⁻). Alternatively, it may have a different pose; this is denoted by the predicate ChangedPose(g, G⁻). With this, the objective function can be written as

ObjFn(I,G⁺,G⁻)=Π_{(g∈G}_{⁺}_{,g∈G}_{^{−}} [symbol] _{SamePose(g,G}_{^{−}}₎₎P(I_{g}|G⁺)P(Keep(g)|G⁻)* (7)

Π_{(g∈G}_{⁺}_{,g∈G}_{^{−}}_{̂ChangedPose(g, G}_{^{−}}₎₎P(I_{g}|G⁺)P(Move(g′,g·pose)|G⁻)*

Π_{(g∈G}_{⁺}_{g∉G}_{^{−}}₎P(I_{g}|G⁺)P(Add(g)|G⁻)*

Π(g∉G_{⁺}_{,g∈G}_{^{−}}₎P(Remove(g)|G⁻);
where I_{g}=Proj(g, G⁺) and g′=g with its pose in G⁻
   Since every image location is under the projection of some unique g in G⁺, equation (7) considers every data item in I. It provides an explicit method of evaluating the probability.

Most physical objects are unchanged from the prior scene. Corresponding objects g in the prior scene model G⁻ are consistent with the data items to which they project in the image and the probability P(I_{g}|G⁻) is high. Such objects are typically carried over from the prior G⁻ to the posterior G⁺.

Where there are changes to the physical scene, there will be objects g in the scene model that are not consistent with the data items to which they project in the image and the probability P(I_{g}|G⁻) is low. Such objects are typically removed when constructing the posteriori G⁺.

Image data that is consistent with a corresponding object is said to be associated with that object. Image data that is not consistent with corresponding objects of the scene model is said to be unassociated. Unassociated data is used to construct new objects that are added to the scene model when constructing the posterior G⁺.

### Scene Changes

The model of scene changes is application specific. However, a few general observations may be made. First, an object is either kept, it is moved or it is removed.

### Hence,

P(Keep(g)|G)+P(Move(g,π)+P(Remove(g)|G)=1 (8)

It is typically the case that the probability of an object being kept is greater than it being removed or moved, that is

P(Keep(g)|G⁻)>P(Remove(g)|G⁻)

P(Keep(g)|G⁻)>P(Move(g,π)|G⁻) (9)

Also, it is typically the case that the probability of an object being moved to a new pose is greater than the object being removed and a new object with identical appearance being added at that pose, that is

P(Move(g,π)|G⁻)>P(Remove(g)|G⁻)P(Add(g′)|G⁻−g) (10)

where π=g′ pose and ImageValues(I, g, G⁻)=ImageValues(I, g′, G⁻) (10)

### Processing Order

Occlusion, as defined by equation (1), specifics a directed graph on objects, in which the nodes are objects and the edges are occlusion relations. When there is no mutual occlusion, the graph has no cycles and there is a partial order. In general there is mutual occlusion, so the graph has cycles and there is no partial order. However, the cycles are typically limited to a small number of objects.

Let g be an object in G⁻. The mutual occluders of g, MutOcc(g) is a sequence of objects, including g, that constitute an occlusion cycle in G⁻ that including g. This may be computed from the set of strongly connected components in the occlusion graph of G that includes g. If |MutOcc(g)|=1, then there are no such other objects. In certain processing steps, all the other members of MutOcc(g) are considered along with g.

The occlusion quasi-order of G is defined to be an ordering that is consistent with the partial order so far as this is possible. Specifically, the quasi-order is a linear order such that that ∀i<k

if G[i]∈MutOcc(G[k])then∀j∈[i,k]G[j]∈MutOcc(G[k]) (11)

if G[i]∉MutOcc(G[k])thenG[k] does not occlude G[i] (12)

Equation (11) requires that all mutual occluders are adjacent in the quasi-order. Equation (12) requires the quasi-order to be consistent with a partial order on occlusion except for mutual occluders where this is not possible.

In certain operations, objects are processed in quasi-order. If there is a partial order, each object is processed before all objects it occludes. Where there is a group G_{C} of mutual occluders of size greater than one, all objects of G_{C} are processed sequentially, with no intervening objects not in that group. All objects not in G_{C} but occluded by objects in G_{C} are processed after the G_{C}.

### Processing Prior Objects

A simple test for the absence of a prior object is that it has no associated data and the probability of its being removed is non-zero. (The probability test insures that the background object is retained, even if it is totally occluded.) Such an object is temporarily removed from the scene model. Either it is not present in the physical scene or it is totally occluded. The latter case is handled by a subsequent step that checks for this case and restores such an object when appropriate.

Prior objects that have some image data associated with them are tested to determine whether they should be kept. An object g_{A} should be kept if the value of ObjFn(I, G⁺, G⁻) is larger with g_{A} in an otherwise optimal G⁺ than without g_{A}. An exact answer would require an exponential enumeration of all choices of keeping or removing each prior object and evaluating the objective function for each choice. Several tests, one described in the first embodiment and others described in the alternative embodiments, provide approximations: One set of techniques compare the probability of the scene model with the object present against the probability of an alternative scene model where the object is absent. The tests may produce a decision to keep or remove; alternatively, they may conclude that no decision can be made, in which case, two scene models are constructed, one with and one without g_{A}, and each is considered in subsequent computation.

### Constructing New Objects

Unassociated image data are passed to a function that constructs new objects consistent with the data. Depending on the application and the type of image data, the function for constructing new objects may use a variety of techniques.

One class of techniques is object recognition from range data. A survey of these techniques is Farshid Arman and J. K. Aggarwal, “Model-based object recognition in dense-range images—a review,” supra. Another survey of these techniques is Paul J. Besl and Ramesh C. Jain, “Three-dimensional object recognition”, supra. Another survey is Roland T. Chin and Charles R. Dyer, “Model-based recognition in robot vision”, supra. A book describing techniques of this type is W. E. L. Grimson, T. Lozano-Perez, and D. P. Huttenlocher, Object recognition by computer. MIT Press Cambridge, Mass., 1990.

Another class of techniques is geometric modeling. A survey of these techniques is Richard J. Campbell and Patrick J. Flynn, “A survey of free-form object representation and recognition techniques”, supra. One technique of this type is described in Ales Jaklic, Alex Leonardis, and Franc Solina. Segmentation and Recovery of Superquadrics. Kluwer Academic Publishers, Boston, Mass., 2000. Another technique of this type is described in A. Johnson and M. Hebert, “Efficient multiple model recognition in cluttered 3-d scenes,” in Proc. Computer Vision and Pattern Recognition (CVPR '98), pages 671-678, 1998.

Another class of techniques is recognizing objects in a collection of object models from image intensity data using features. One such technique is described in David G. Lowe, “Distinctive image features from scale-invariant keypoints”, supra. Other techniques are described in, Mikolajczyk, K. Schmid, C, “A Performance Evaluation of Local Descriptors, supra.

U.S. Pat. No. 7,929,775, issued Apr. 19, 2011, and entitled “System and Method for Recognition in 2D Images Using 3D Class Models,” describes an object modeler for the case where the image data is intensity data and the models are 3D class models.

U.S. patent application Ser. No. 12/287,315, filed Oct. 8, 2008, entitled “System and Method for Constructing a 3D Scene Model from an Image,” describes an object modeler for the case where the image data is range data and the models are Platonic solids.

Irrespective of particular technique, the function for constructing new objects from image data is referred to as an object modeler.

The ability of the object modeler to construct suitable new objects is the ultimate limitation on any method for constructing a scene model from an image. First, it limits the kinds of scene changes that can be handled. For example, if the object modeler is based on object recognition, only scenes involving known objects can be handled; if it is based on shape recognition, only scenes involving particular shapes can be handled. Second, methods for constructing scene models can produce sensible posterior scene models only to the extent that the new objects it constructs are sensible. Hence, it is assumed that given image data that corresponds to new physical objects, the object modeler will construct new objects that correspond to these physical objects.

In this structure, the object modeler operates on regions of unassociated data items. For the common situation, where only some parts of the image are changed, these regions are considerably less than the entire scene and often disjoint. Hence, the work of the object modeler in this context is simpler than one that tasked with interpreting the entire image ab initio. Usually, the work is significantly simpler.

### Moved Objects

After prior objects have been processed and new objects have been added to the scene model, it is desirable to check for objects gₚᵣᵢₒᵣ that have been moved to a new pose, i.e. their location or orientation have changed. In this case, the object modeler will typically have created a single new object g_{new} corresponding to the moved physical object. This situation is identified and g_{new} is replaced by the original gₚᵣᵢₒᵣ, with the pose of gₚᵣᵢₒᵣ changed to the pose of g_{new}.

### Evaluating Posterior Scene Models

After prior objects have been processed, new objects added, and moved objects processed, the result is a set of one or more posterior scene models. The probability of each scene model is computed. One or more scene models having high probability may be selected.

### EXAMPLES

Some examples will illustrate the utility of various embodiments, showing the results computed by some typical embodiments.

Suppose there is a cluttered scene model with a large number of objects, many partially occluded, corresponding to a physical scene. Subsequently, one physical object is added and one physical object is removed. An image is then acquired. If it were given the entire image, the object modeler would be confronted with a difficult problem due to the scene complexity. In one embodiment, using a prior scene model allows the method to focus on the changes, as follows:

[1] It detects the physical removal because the corresponding object in the prior scene model lacks associated data in the image and it removes the object. The relevant image data is associated with other objects in the prior scene model that were previously occluded by the removed object.
[2] Subsequently, it detects the physical addition because there is unassociated image data and it passes that data to the object modeler, which is thereby given the relatively simple task of constructing a new object for just that data.

As a second example, suppose there is a scene model with an object g. Subsequently, a physical object is placed in front of g, occluding it from direct observation from the observer pose. Then an image of the scene is acquired. Persistence suggests that g has remained where it was, even though it appears nowhere in the image, and this persistence is expressed in the dynamic model. In the typical cases where P(Keep(g)|G⁻)>P(Remove(g)|G⁻), one embodiment computes a posterior scene model in which the occluded object g remains present. (Specifically, it first removes g because it has no associated image data and later restores g if it is totally occluded and is free from collision with any other object.) Using a prior scene model allows the method to retain hidden state, possibly over a long duration in which the object cannot be observed.

Suppose there is a scene model with a prone cylinder g_{C}. Subsequently, an object g_{F} is placed in front of it, occluding the middle. The image shows g_{F} in the foreground and two cylinder segments behind it. Persistence suggests that the two cylinder segments are the ends of the prior cylinder g_{C}. In the typical case where probability of an object being kept is greater than its being removed, one embodiment computes a new scene model with g_{C} where it was and g_{F} in front of it. Using a prior scene model allows the method to assign two image segments to a common object.

Suppose there is a scene model with an object g. Subsequently, g is moved to a new pose. The image shows data consistent with g but with changed pose. Persistence suggests that g has been moved and this persistence may expressed in the dynamic model. In the typical case where the probability of an object being moved to a new pose is greater than the object being removed and a new object with identical appearance being added at that pose, one embodiment computes a new scene model in which object g has been moved to a new pose. Using a prior scene model and a dynamic model allows the method to maintain object identity over time.

In each of the last three cases, there are alternative scene models consistent with the image. In case of total occlusion, the object g could be absent; in case of the partially occluded cylinder, the cylinder g could have been removed and two shorter cylinders added; in case of the object moved, it is possible that object g has been removed and a similar object added at a new pose. In each case, the prior scene model and the model of scene changes make the alternative less likely.

### First Embodiment

### Overview

The first embodiment is a method designated herein as the CbBranch Algorithm described in detail below. For clarity in exposition, it is convenient to first describe in various auxiliary functions in English where that can be done clearly. Then the body of the algorithm is described in pseudo-code where the steps are complex.

In the first embodiment, the data are pixels, so that r denotes a pixel. Typically, but not necessarily, the data values are range values.

### Auxiliary Functions

### QuasiOrder

The function QuasiOrder(G) takes a scene model G. It returns a reordering of G in occlusion quasi-order, as described above. It operates at follows: First, it computes the pairwise occlusion relations from equation (1) and constructs a graph of the occlusion relations. It computes the strongly connected components of that graph. It then constructs a second graph in which each strongly connected component is replaced by a single node representing that strongly connected component. Next, it orders the second graph by a typological sort, thereby producing an ordered sequence. Then, it constructs a second ordered sequence by replacing each strongly connected component node with the objects in that strongly connected component. The result is the objects of G in quasi-order. From the sequence of strongly connected components, it computes the sequence of mutual occluders, MutOcc(g) for each object g and caches the result. Methods for computing strongly connected components and typological sort of a directed graph are well known in the literature, e.g. as described in Corman, Leiserson, and Rivest, Algorithms, New York, 1990.

### MutOcc(g, G)

The function MutOcc(g, G) takes an object g and a scene model G. It returns the sequence of mutual occluders of g in G. Operationally, the function is computed for each g in G as Quasi Order(.) is computed; and the results are cached.

### DataError

The function DataError(r, I, G) is the difference between the image data at datum r and the scene model at r. In general, the data error, e, is a vector.

DataError(r,I,G)=ImageValue(r,I)−ModelValue(r,G)=e (14)

The probability, pₑ(e) of a data error e is the probability that the data error occurs, which depends on the specific model for data errors. The probability pₑ(e) deals with two relationships: (1) the fidelity of new models constructed by the object modeler to the image used for their construction and (2) the relationship of the image used for construction to subsequent images. The former is determined by the object modeler: some object modelers are faithful to image details; others produce ideal abstractions. The latter is a function of image variation, primarily due to image noise.

Where the issue is primarily image noise, a suitable model for data errors is typically a contaminated Gaussian, c.f. Huber P. and Ronchetti E. (2009) Robust Statistics, Wiley-Blackwell. Let Σ be the covariance matrix of the errors, Φ a zero-mean unit variance Gaussian distribution, β the contamination percentage, β a uniform distribution over the values range of values from lₖ to uₖ of the kth element of the error vector, and n the length of the error vector. The error has the probability density function

pₑ(e;α,Θ,l,u)=(1−β)Φ(e^{T}Σ⁻¹e)+βΠₖU(lₖ,uₖ) (15)

### P(I_{g}|G)

The probability P(I_{g}|G), where I_{g}=Proj(g, G), appears in three factors of the objective function. It is defined as follows. Let ObjectError(g, I, G) be the set {DataError(r, I, G)|r∈I_{g}}. In this first embodiment, the quantification r∈I_{g} is over pixels; in other embodiments, the quantification may be over features. Let P_{E}(.) be the probability density function for the model of object errors. Then

P(I_{g}|G)=P_{E}(ObjectError(g,I,G)) (16)

Typically, it is assumed that the data errors are independent, so that

P(I_{g}|G)=Π(r∈I_{g})pₑ(DataError(r,I,G)) (17)

### Associated

The function Associated(I, g) returns the data of image I that that are associated with an object g. This is defined in terms of a predicate IsAssociatedDatum, as follows:

Let r∈Proj(g, {g}) and let e=DataError(r, I, {g}) be the error at r for the object g in isolation. Let Σ be the covariance matrix of the errors when an object is present in the image. The quadratic form e^{T}Σ⁻¹ scales the error e by the covariance. Let τ_{A} be the threshold for data association expressed in units of standard deviation. Define the predicate IsAssociatedDatum(r, I, g), meaning that datum r in image I is associated with object g, as

IsAssociatedDatum(r,I,g)=e^{T}Σ⁻¹e≦(τ_{A}) (18)

The two-place function, Associated(I, g) is defined as

Associated(I,g)={r∈I|IsAssociatedDatum(r,I,g)} (19)

### Unassociated

The function Unassociated(I, G) returns the data of image I that that is not associated with any object in G. It is defined as

Unassociated(I,G)={∀r∈I|∀g∈G, not IsAssociatedDatum(r,I,g)} (20)

Unassociated data are used by the object modeler to construct new objects.

A small value of the threshold τ_{A} requires that associated data have a small error, but correspondingly rejects more data. Hence, a small value of τ_{A} results in some number of spurious unassociated data, which act as clutter that the object modeler must ignore. A large value of τ_{A} results in some number of spurious associated data, and correspondingly the absence of unassociated data, which may create holes that the object modeler must fill in or otherwise account for. Either may cause additional computation or failure of the object model to find a good model. Their relative cost depends on the particular characteristics of the object modeler and the distribution of image errors. The threshold τ_{A} is chosen to balance these costs.

Under normal circumstances with a contaminated Gaussian, a typical value is 3. However, the choice depends also on the size of anticipated changes in scenes relative to the size of sensor error. If the former is large relative to the latter, a large (3, 4, 5) value of τ_{A}, is appropriate. If not, smaller values may be used.

### ModelNewObjects

The function ModelNewObjects(Dᵤ, G, G⁻) computes a set of new objects G_{N} that model the data Dᵤ, in the context of scene model G. Various techniques operating where the data is pixels may be used to compute this set. One specific technique, where the data is pixel range values, is described in U.S. Patent Application No. 20100085358, filed Oct. 8, 2008, entitled “System and Method for Constructing a 3D Scene Model from an Image” This technique is also described in Gregory D. Hager and Ben Wegbreit, “Scene parsing using a prior world model”, International Journal of Robotics Research, Vol. 30, No. 12, October 2011, pp 1477-1507.

ModelNewObjects is required to have the property that each g∈G_{N} does not collide with any object in G+G_{N}. Where an object modeler does not otherwise have this property, the techniques of U.S. Patent Application No. 20100085358, supra, may be used to adjust the pose of objects so that there is no collision.

Given image data that corresponds to new physical objects, ModelNewObjects should construct new objects that correspond to these physical objects. Also, the predicate for data association, τ_{A}, is chosen so that if g is an object produced by the object modeler and r is a datum in Proj(g, G), the predicate IsAssociatedDatum(r, I, g) is true with at most a controlled number of outliers that fail this test.

If for some image the first property does not hold, it is not possible to construct a complete posterior scene model. The best that can be done is to compute a partial posterior scene model and the first embodiment does this. Where there is data the object modeler cannot handle, e.g. the image of a donut-shaped object presented to a modeler restricted to Platonic solids, such areas are left unmodeled. Such areas will be under the projection of some g, typically the background object, and will have a low probability in the objective function. In the extreme case where no objects can be constructed consistent with the data, ModelNewObjects returns the empty set.

The object modeler may segment Dᵤ into a set of disjoint connected components, as follows. A predicate IsConnected may be defined on pairs of pixels that are in a 4-neighborhood. For example, two pixels may satisfy this predicate if their depth values or intensity values are similar. Two pixels in Dᵤ are connected if they satisfy IsConnected. A set C of pixels in Dᵤ is connected if all pixels are connected to each other. Thus, Dᵤ may be segmented into a set {C₁ . . . Cₙ} where each Cₖ is connected and no Cₖ is connected to any other Cⱼ.

The relationship between the new objects G_{N} and {C₁ . . . Cₙ} depends on the object modeler.

A simple object modeler might compute at most one object for each connected component Cₖ
An object modeler able to perform segmentation might compute multiple objects for a single Cₖ when appropriate.
A particularly sophisticated object modeler might identify parts of a single physical object in multiple Cₖs and compute, as part of G_{N}, an object g that spans these Cₖs, where occluders separate the visible parts of g.

### TotallyOccluded

The function TotallyOccluded(g, G) is true if the object g is not visible, that is Proj(g, G)=Ø.

### CollisionFree

The function CollisionFree (g, G) returns 1 if there is no interpenetration of g with any object in G and 0 otherwise.

### Algorithm CbBranch

Algorithm CbBranch computes a posteriori scene model from a prior scene model and an image.

The functions below are written in abstract code using a syntax generally conforming to C++ and Java. Comments are preceded by //. Subscripting is denoted by [ ]. The equality predicate is denoted by ==. Assignment is denoted by =, +=, and −=. Variables and functions are declared to have a data type by prefixing the variable by its type. Data types are distinguished by being written in italic. Data types include Image, SceneModel, and Object. Most functions return a tuple, declared for example as <SceneModel, double>. To keep the description clear and compact, set notation is used extensively.

Algorithm CbBranch has five phases. In outline, these phases operate as follows:

Phase 1 removes objects from G⁻ that have no image data associated with them.
Phase 2 traverses the remainder of G⁻ in occlusion order, removing objects that are not consistent with the image and the model of scene changes and keeping objects that are consistent. Where it cannot make a conclusive determination, it branches, calling itself recursively; each branch eventually executes all the phases, and computes its probability; the branch with the maximum probability is returned.
Phase 3 constructs new objects for image data not associated with objects kept in Phase 2.
Phase 4 handles objects that have been moved, replacing new objects by the result of moving kept objects where appropriate. Also, it replaces certain objects removed in phase 1 that are totally occluded.
Phase 5 computes the objective function on the resulting posterior scene model and returns this value to be used in computing the maximum in Phase 2.

### CbBranch1

The main function is CbBranch1. This takes two arguments: an Image I and a prior SceneModel G⁻. It executes Phase 1, then calls CbBranch2 to do the other phases. It returns a posterior SceneModel G⁺.

| | |
|---|---|
| SceneModel CbBranch1( Image I, SceneModel G⁻) { | (21) |

SceneModel Gₖₑₚₜ = Ø;
// Phase 1: Remove objects that have no image data consistent with
them
G⁻ = QuasiOrder(G⁻);
SceneModel G_{removed} = { g ∈ G⁻ | Associated(I, g) =
Ø [symbol] P(Remove(g) | G⁻) > 0 };
SceneModel G_{Q} = G⁻ − G_{removed};
SceneModel G_{todo} = G_{Q};
SceneModel G⁺; double p;
// Call CbBranch2 to perform the remaining phases
< G⁺, p> = CbBranch2(Gₖₑₚₜ, G_{todo});
return G⁺;
}

### CbBranch2

Turning to the remaining phases, CbBranch2 takes two explicit arguments: the sequence of objects Gₖₑₚₜ that are to be kept and the sequence of objects G_{todo} that have not yet been processed. It returns a tuple <G, p> consisting of a posterior scene model G and the value p of the objective function applied to G.

To reduce code clutter, several notational devices are used below. The image I, the prior scene model and the ordered prior scene model G_{Q} are treated as global parameters. The function TupleMax is used to choose one of two tuples, the one with the higher probability. It is defined as

TupleMax(<G_{A},p_{A}>,<G_{B},p_{B}>)=if(p_{A}>p_{B})then<G_{A},p_{A}>else<G_{B},p_{B}> (22)

CbBranch2 processes the first item g of G_{todo}: It calls ObjectPresent to evaluate whether the g should be kept or not. There are three possibilities: g should be kept, g should be removed, or the situation is uncertain, so both possibilities must be considered. It then calls itself recursively to handle the rest of G_{todo}. Depending on g, the recursion is either a tail recursion or a binary split. In the latter case, the fork with the larger probability is eventually chosen. When a recursive call finds G_{todo} empty, the sequence of kept items has been previously determined, so CbBranch executes the remaining phases, concluding by evaluating the objective function for that case.

| | |
|---|---|
| // CbBranch2 returns a pair of type <SceneModel, double> | (23) |

<SceneModel, double>
CbBranch2( SceneModel Gₖₑₚₜ, SceneModel G_{todo}) {

if (G_{todo} ≠ Ø ) {

| // Phase 2: Remove objects that fail the ObjectPresent test | |
|---|---|
| Object g = G_{todo}.first; | |
| G_{todo} = G_{todo}.rest; | |
| double φ = ObjectPresent( I, g, Gₖₑₚₜ + G_{todo} ); | |
| if ( φ =1 ) return CbBranch2( Gₖₑₚₜ+g, G_{todo}); | // Keep g |

| // Otherwise remove must be considered | |
|---|---|
| // The remove case has two sub-cases, depending on g and its mutual occluders | |
| SceneModel G_{C} = MutOcc( g, G_{Q}); | |
| SceneLodel Gᵣₑₘₒᵥₑ; double pᵣₑₘₒᵥₑ; | |
| if ( g == G_{C}.first ) < Gᵣₑₘₒᵥₑ, pᵣₑₘₒᵥₑ > = CbBranch2( Gₖₑₚₜ, G_{todo}) | |
| else < Gᵣₑₘₒᵥₑ, pᵣₑₘₒᵥₑ > = ProcessMutOcc( G_{C}, Gₖₑₚₜ, G_{todo}); | |
| if ( φ = 0 ) return < Gᵣₑₘₒᵥₑ, pᵣₑₘₒᵥₑ >; | // Remove g |

// Compute both branches and choose the one with the larger probability
return TupleMax ( CbBranch2(Gₖₑₚₜ+g, G_{todo}), <Gᵣₑₘₒᵥₑ, pᵣₑₘₒᵥₑ > );

} // end of (G_{todo} ≠ Ø )

// Phase 3: Construct new objects from image data
// that cannot be associate with any kept object
ImageRegion D_{new} = Unassociated(I, Gₖₑₚₜ);
SceneModel G_{new} = ModelNewObjects(D_{new}, Gₖₑₚₜ, G⁻);
// Phase 4: Handle objects moved and totally occluded objects
SceneModel G_{removed} = G⁻ − Gₖₑₚₜ;
SceneModel G_{moved} = Ø;
< G_{moved}, G_{removed}, G_{new}> = ObjectsMoved(Gₖₑₚₜ, G_{removed}, G_{new});
SceneModel G⁺ = Gₖₑₚₜ + G_{moved} + G_{new};
G⁺ += { g ∈ G_{removed} | TotallyOccluded(g, G⁺) [symbol] CollisionFree(g, G⁺)

[symbol]

P(Keep(g) | G⁻) > P(Remove(g) | G⁻) };

// Phase 5: Evaluate the objective function on the posterior scene model
double p = ObjFn(I, G⁺, G⁻);
return < G⁺, p>;

}

In the typical case, when a physical object is removed, the image region it occupied appears different in the new image. Let g be the object in the scene model that corresponds to a removed physical object. Then no image data is associated with g. In this case, phase 1 above removes all such prior objects. The unassociated data corresponds exactly to the new physical objects. In this case, the operation of phase 2 is particularly simple: each object in G_{todo} passes the ObjectPresent test (i.e. ObjectPresent returns 1) and there is no Phase 2 branching. The atypical case is discussed below.

In this process, new objects are constructed for two different purposes. First, they are constructed on a temporary basis in ObjectPresent, as described below. Second, there is a final execution of using unassociated data to compute new objects in Phase 3 above; this final execution is performed after all executions of the Phase 2 step of removing all inconsistent objects.

### ObjectPresent

The function ObjectPresent is used by CbBranch to decide whether it should keep an object g_{A}, remove that object, or consider both cases. An object should be removed if it is inconsistent with the image and the model of scene changes. Specifically, the object g_{A} should be kept if the value of ObjFn(I, G⁺, G⁻) is larger with g_{A} in G⁺ than without it. An exact answer would require an exponential enumeration of all choices of keeping or removing each object in G⁻, computing new objects, and evaluating the objective function for each choice. The function ObjectPresent provides a local approximation to the optimal decision.

It compares the probability of the current scene model G with the object g_{A} present against the probability of an alternative scene model where the object is absent. Specifically, it approximates it comparison by considering only the relevant portion of the image, the projection of the object g_{A}. It is convenient to refer to the comparison on the relevant portion of the image as comparing the probability of the 3D scene model where the object is present against the probability of the 3D scene model where the object is absent. For each case, object present or object absent, it finds the unassociated data, computes temporary new objects from the unassociated data, and evaluates the objective function with the g_{A} kept or removed and the new objects, resulting in two probabilities, P_{with} and Pₐₗₜ.

In each case, g_{A} is evaluated in the context of occluding objects. Objects in the prior scene model are evaluated in occlusion order, so the determination of possibly occluding kept or removed prior objects has already been made. New objects are computed by ModelNewObjects. These new objects are local approximations to the final set of new objects, so they are temporary. They are computed in ObjectPresent, used in computing the two probabilities, and then discarded.

The ratio φ=P_{with}/(p_{with}+pₐₗₜ) is a local approximation to the optimal test for g being present in the optimal scene model. If the current G were otherwise optimal, and the only decision to be made is whether or not g_{A} should be kept, it would suffice to test whether φ≧½, which is equivalent to the test p_{with}≧pₐₗₜ.

Since the current G is not necessarily optimal, the test φ≧½ is not guaranteed to be a prefect indicator of whether keeping an object will lead to a globally optimal solution. In particular, when φ is close to ½, the chance of error is large since small image differences can push the value to be either greater than or less than ½.

However, for values of φ far from 1/2, φ becomes an increasingly reliable indicator. ObjectPresent uses two settable thresholds τᵣₑₘₒᵥₑ and τ_{kecp}, where 0≦τᵣₑₘₒᵥₑ≦τₖₑₑₚ≦1+∈;
(1) If φ≧τₖₑₑₚ, the algorithm considers that g is kept and returns the indicator value 1.
(2) If φ<τᵣₑₘₒᵥₑ, the algorithm considers that g is removed and returns the indicator value 0.
(3) Otherwise, the algorithm considers that no decision can be made and returns the indicator value 0.5.

The thresholds are externally determined. If they are chosen so that τₖₑₑₚ=Tᵣₑₘₒᵥₑ=½, then ObjectPresent returns either 0 or 1 and Phase 2 has no branching. This is a suitable choice where speed is essential. If τₖₑₑₚ=1+∈ and τᵣₑₘₒᵥₑ=0, Phase 2 of CbBranch is called an exponential number of times, enumerating all possibilities of each object being kept or removed. The choice of values for these thresholds depends on the requirements of the application: choosing values close to each other, typically on either side of ½, to achieve speed and choosing values far apart to explore more alternatives and increase the likelihood that the result is optimal.

The function ObjectPresent takes three arguments: an Image I, an Object g, and a SceneModel G of objects in G⁻ that have not been removed. It returns a double: 1 if g is to be kept, 0 if g is to be removed; and 0.5 if both the kept and removed versions should be considered.

| | |
|---|---|
| double ObjectPresent( Image I, Object g, SceneModel G) { | (24) |

| | |
|---|---|
| ImageRegion I_{gg} = Proj(g, {g}); | // The projection of g in isolation |

// Compute p_{with}, the value of the objective function with g in the scene model
ImageRegion D_{w} = Unassociated(I, g+G);
SceneModel G_{new} = ModelNewObjects(D_{w}, g+G, G⁻);
double p_{with} = ObjFn(I_{gg}, g+G+G_{new}, G⁻);
// Compute pₐₗₜ, the value of the objective function where g is not in the scene model
ImageRegion Dₐₗₜ = Unassociated(I, G);
SceneModel Gₐₗₜ = ModelNewObjects(Dₐₗₜ, G, G⁻);
double pₐₗₜ = ObjFn(I_{gg}, G+Gₐₗₜ, G⁻);
// Compare p_{with} to pₐₗₜ
double φ = p_{with} / (p_{with} + pₐₗₜ);
if (φ ≧ τₖₑₑₚ ) return 1;
if (φ < τᵣₑₘₒᵥₑ ) return 0;
return 0.5;

}

In the above, the objective function, ObjFn, is extended to apply to the case where the I_{gg} is a subset of I by restricting the image data to I_{gg} and restricting the Remove factors to objects that project to

Consider the typical case: when a physical object is removed, the image region it occupied appears different in the new image. The unassociated data at the end of Phase 1 corresponds exactly to the new physical objects. ModelNewObjects(D_{w}, g+G, G⁻) computes new model objects corresponding to the new physical objects, while ModelNewObjects(Dₐₗₜ, G, G⁻) typically computes these objects plus a new version of g. In the normal case where the probability of an object being kept is greater than its being removed, p_{with} is greater than pₐₗₜ, ObjectPresent returns 1, and the object is kept.

In the atypical case, one or more physical object is removed and the image region previously occupied includes some data that is the same in the new image. In this case, this data is erroneously associated with objects that should be removed. Suppose that the argument, g, to ObjectPresent is such an object that should be removed. The probability ObjFn(I_{gg}, g+G+G_{w}, G⁻) is typically low because g is a poor match for the image data. In contrast, ObjFn(I_{gg}, G+Gₐₗₜ, G⁻) is typically larger. Unless the model of scene changes overwhelmingly supports g being kept, p_{with} is less than pₐₗₜ, ObjectPresent returns 0, and the object is removed. If a substantial amount of data is the same, the situation may be ambiguous and ObjectPresent may return 0.5 so that both possibilities are considered.

### ProcessMutOcc

The function ProcessMutOcc handles sequences of mutual occluders of size greater than one. Mutual occluders require special treatment because they break the partial order used by CbBranch2. When there is a partial order, CbBranch2 can process each object in G⁻ after it has processed all its occluders in G⁻.

However, in a sequence of mutual occluders, this is not the case. The value of ObjectPresent applied to an object can change as members of a sequence G_{C} of mutual occluders are removed, so that objects that previously passed the ObjectPresent test might not were the test repeated. The solution is to reconsider all the members G_{C} whenever any object in G_{C} is removed. The function ProcessMutOcc does that.

ProcessMutOcc is called by CbBranch when the latter has determined that an object it has just removed is part of a sequence of mutual occluders G_{C} and a segment of G_{C} is in Gₖₑₚₜ. ProcessMutOcc moves the segment from Gₖₑₚₜ to G_{todo} so the segment will be processed again and calls CbBranch2. Hence its return data type is the return data type of CbBranch2.

| | |
|---|---|
| <SceneModel, double> | (25) |

ProcessMutOcc (SceneModel G_{C}, SceneModel Gₖₑₚₜ, SceneModel G_{todo}) {

int i = smallest k such that Gₖₑₚₜ[k] is a member of G_{C};
int n = | Gₖₑₚₜ |;
// Reconsider the decisions re Gₖₑₚₜ[i:n],
G_{todo} = Gₖₑₚₜ[i:n] + G_{todo};
Gₖₑₚₜ = Gₖₑₚₜ [1:i−1];
return CbBranch2(Gₖₑₚₜ, G_{todo});

}

### ObjectsMoved

The final function, ObjectsMoved, handles objects whose pose (location or orientation) has changed. An object gₚᵣᵢₒᵣ may fail the ObjectPresent test either (1) because the corresponding physical object is absent or (2) because the physical object is has been moved to a new pose. In case (2), an object modeler will typically create a single new object g_{new} corresponding to the moved physical object. Typically, the probability of an object being moved is greater than it's being removed and another of similar appearance added. When this is the case, it is desirable to identify this situation and replace g_{new} by the original gₚᵣᵢₒᵣ, with the pose of gₚᵣᵢₒᵣ changed to the pose of g_{new}.

The function ObjectsMoved does this. For each g_{new}∈G_{new}, it considers each element of G_{removed} and finds the most suitable candidate to replace g_{new}. Such a replacement, when moved to pose π_{new}, must

(1) Fit into the scene model without collision with other objects. This is tested by the function CollisionFree, which returns either 1 or 0.
(2) Provide an acceptably good match to the image at the projection of g_{new}. This is computed by the factor P(I_{new}|ChangePose(g, π_{new})+G_{remainder})
(3) Be acceptably likely according to dynamic model. This is tested by the factor P(Move(g, π_{new})|G⁻).

ObjectsMoved finds the object in G_{removed} that best meets these criteria and assigns it to gₚᵣᵢₒᵣ. The object gₚᵣᵢₒᵣ is then compared with g_{new} by computing the relevant factors of the objective function. If replacing g_{new} with gₚᵣᵢₒᵣ increases the local probability, ObjectsMoved adds gₚᵣᵢₒᵣ to G_{moved} and removes g_{new} from G_{new}.

The function ObjectsMoved takes three SceneModels: Gₖₑₚₜ, G_{removed}, and G_{new}. It returns a triple: G_{moved}, G_{removed}, and G_{new}, all as modified by the function.

| | |
|---|---|
| < SceneModel, SceneModel, SceneModel > | (26) |

ObjectsMoved (SceneModel Gₖₑₚₜ, SceneModel G_{removed}, SceneModel
G_{new}) {

SceneModel G_{moved} = Ø; SceneModel G_{const} = G_{new};
for (int k=1; k ≦ |G_{const}|; k++) {

Object g_{new} = G_{const}[k];
Pose π_{new} = g_{new}.pose;
SceneModel G_{current} = Gₖₑₚₜ + G_{moved} + G_{new};
ImageRegion I_{new} = Proj( g_{new}, G_{current});
double p_{new} = P( I_{new} | G_{current}) * P( Add(g_{new}) | G⁻);
SceneModel G_{remainder} = G_{current} − g_{new};
Object gₚᵣᵢₒᵣ = ArgMax _{(g ∈G}_{_{removed}} ₎

```
( CollisionFree( ChangePose(g, π_{new}), G_{remainder}) *
  P( I_{new} | ChangePose(g, π_{new}) + G_{remainder}) *
  P( Move(g, π_{new}) | G⁻) );
```

double pₚᵣᵢₒᵣ = CollisionFree( ChangePose(gₚᵣᵢₒᵣ, π_{new}),
G_{remainder}) *

P( I_{new} | ChangePose(gₚᵣᵢₒᵣ, π_{new}) + G_{remainder}) *
P(Move(gₚᵣᵢₒᵣ, π_{new}) | G⁻);

if ( pₚᵣᵢₒᵣ > p_{new} ) {

G_{new} −= g_{new}; G_{removed} −= gₚᵣᵢₒᵣ;
G_{moved} += ChangePose(gₚᵣᵢₒᵣ, π_{new} );

}

} // end of for loop
return <G_{moved}, G_{removed}, G_{new}>;

}

### Alternative Embodiments and Implementations

The invention has been described above with reference to certain embodiments and implementations. Various alternative embodiments and implementations are set forth below. It will be recognized that the following discussion is intended as illustrative rather than limiting.

There are many alternative embodiments of the present invention. Which is preferable in a given situation may depend upon several factors, including the object modeler and the application. Various applications use various image types, require recognizing various types of objects in a scene, have varied requirements for computational speed, and varied constraints on the affordability of computing devices. These and other considerations dictate choice among alternatives.

### Operating on Multiple Prior Scene Models and Computing Multiple Posterior Scene Models

The first embodiment computes a single scene model with the highest probability of the alternatives considered. In alternative embodiments, multiple alternatives may be returned. One method for doing this is to modify the functions CbBranch1 and CbBranch2 as follows:

[1] Where CbBranch2 returns one of two alternatives, in (23)

TupleMax(CbBranch2(Gₖₑₚₜ+g,G_{todo}),<Gᵣₑₘₒᵥₑ,pᵣₑₘₒᵥₑ>);

an alternative embodiment would return a sequence

[CbBranch2(Gₖₑₚₜ+g,G_{todo}),<Gᵣₑₘₒᵥₑ,pᵣₑₘₒᵥₑ>] (27)

where each element of the sequence is a pair <G⁺, p>. In consequence, the first call to CbBranch2 finally returns a sequence of all the alternatives considered.
[2] Where CbBranch1 returns scene model part of the pair in (22)<

<G⁺,p>=CbBranch2(Gₖₑₚₜ,G_{todo});
return G;
   an alternative embodiment would sort the sequence and return the sorted result

Sequence s=CbBranch2(Gₖₑₚₜ,G_{todo}); (28)
Sequence sortedS=sort the sequence s by the probabilities return sortedS;

In alternative embodiments, multiple prior models may be supplied. Where CbBranch1 takes as argument a single prior SceneModel, G⁻, an alternative embodiment would take as argument a set of SceneModels, S⁻. It operates on each G⁻∈S⁻, merges the results, and returns the sorted merge.

### Alternative Models of Scene Change

In the description above, the model of scene change is P(Keep(g)|G⁻), P(Remove(g)|G⁻), P(Add(g)|G⁻), and P(Move(g, π_{new})|G⁻) where π_{new} is the new pose of g. In other embodiments, more complex models may express various sorts of change dependencies. In particular, there may be dependencies between the probabilities of multiple removals, multiple addition, or multiple moves.

### Alternative Versions of the Function ObjectPresent

In the first embodiment, the test for an object being kept in Phase 2 is performed by the function ObjectPresent. In alternative embodiments, the test may be performed by variations and other functions.

One variation is in the comparison of the probability of the 3D scene model where the object is present against the probability of the 3D scene model where the object is absent. In ObjectPresent, the comparison is carried out on a subset of the image, I_{gg}, i.e. the projection of the object. In alternative embodiments, this comparison can be carried out over the entire image.

An alternative function is ObjectPresentA. It is more conservative than ObjectPresent in that it may decide in additional situations to consider both alternatives, keep and remove. It deals with the following issue: Consider the ImageRegion I_{gg}=Proj(g, {g}), which is used in the probability ObjFn(I_{gg}, g+G+G_{new}, G⁻). I_{gg} may be divided into two sub-regions: Proj(g, g+G+G_{new}) and I_{gg}−Proj(g, g+G+G_{new}). The latter sub-region may include Proj(G_{new}, g+G+G_{new}). Suppose that G_{new} is a poor model because ModelNewObjects is unable to construct a good model due to the absence of unassociated data in Dᵤ—data that should be in Dᵤ but is associated with a prior object g_{R} that has not yet been removed. Although occluding objects have already been removed due to the use of occlusion order, data associated with g_{R} might be needed to correctly construct G_{new}. This is a corner case, but it could occur with certain object modelers.

In this situation, ObjFn(I_{gg}, g+G+G_{new}, G⁻) may compute a low probability, not because g is ill matched to the image but rather because G_{new} is a poor model. This situation may be detected by checking whether G_{new} is a valid model in the relevant region. When not, no reliable determination can be made, so ObjectPresentA returns the code 0.5, which causes CbBranch2 to consider both alternatives.

| | |
|---|---|
| double ObjectPresentA( Image I, Object g, SceneModel G) { | (29) |

| | |
|---|---|
| ImageRegion I_{gg} = Proj(g, {g}); | // The projection of g in isolation |

| // Compute p_{with}, the value of the objective function with g in the scene model | |
|---|---|
| ImageRegion D_{w} = Unassociated(I, g+G); | |
| SceneModel G_{new} = ModelNewObjects(D_{w}, g+G, G⁻); | |
| SceneModel G_{c} = g+G+G_{new}; | |
| ImageRegion Iₚ = I_{gg} ∩ Proj(G_{new}, G_{c}); | // Projection of G_{new} on I_{gg} |
| if (not ValidModel(I, Iₚ G_{c},)) return 0.5; | // G_{new} is not valid on Iₚ |

double p_{with} = ObjFn(I_{gg}, g+G+G_{new}, G⁻);
// Compute pₐₗₜ, the value of the objective function where g is not in the scene model
ImageRegion Dₐₗₜ = Unassociated(I, G);
SceneModel Gₐₗₜ = ModelNewObjects(Dₐₗₜ, G, G⁻);
double pₐₗₜ = ObjFn(I_{gg}, G+Gₐₗₜ, G⁻);
// Compare
double φ = p_{with} / (p_{with} + pₐₗₜ);
if (φ ≧ τₖₑₑₚ ) return 1;
if (φ < τᵣₑₘₒᵥₑ ) return 0;
return 0.5;

}

The above test for validity is performed by the function ValidModel. This takes an Image I, an ImageRegion Iₚ and a SceneModel G. It returns a boalean: true iff G is an valid scene model on Iₚ.

ValidModel uses several global variables defined as follows:

Let Σ be the covariance matrix of the errors when an object is present in the image.
Let τ_{A} be the threshold for data association.
Let κ be the threshold for rejecting a model.
Let E be the set of errors e such that e^{T}*Σ⁻¹*e>(τ_{A})².
Let x be the integral of pₑ over this E, so that x is the probability that the normalized error exceeds τ_{A}. For particular data error models, tables or specific approximations can be employed. For example, for a Gaussian error model, x=1−erf(τ_{A}/sqrt(2)), where erf is the Gauss error function.

| | |
|---|---|
| boolean ValidModel( Image I, ImageRegion Iₚ, SceneModel G) { | (30) |

double nErrors = 0; double n = 0;
forall Datum r ∈ Iₚ {

| n++; | // Tally the number of data items |
|---|---|
| Vector e = DataError(r, I, G); | |
| // Tally the number of times that the normalized error is excessive | |
| if ( e^{T} * Σ⁻¹ * e > (τ_{A})² ) nErrors++; | // Tally the number of errors |

}
double nReject = n*x + κ * (n*x*(1−x))^{1/2};
if ( nErrors > nReject) return false;
return true;

}

The set of data items in Iₚ such that the data error exceeds τ_{A} can be modeled as a binomial random variable with probability x and n observations, where n is the number of data items in Iₚ. That binomial distribution can be approximated by a normal distribution with mean n*x and standard deviation (n*x*(1−x))^{1/2}. The threshold for rejection, nReject, is expressed above as the mean plus a control threshold x times the standard deviation. Values of κ=5 are typically effective for Gaussian error models or contaminated Gaussians under circumstances where the sensor error is small relative to anticipated changes in scenes, which is typically the case for high resolution range and intensity imagers and natural world scenes. Smaller values maybe appropriate in other situations. In typical situations, there are only a small number of new physical objects. Hence, in most calls on ValidModel, Iₚ is empty and the function returns true.

A different approach to testing whether an object should be kept is employed by ObjectPresentB. This function uses the expected value of the error model to compute the probability of an alternative. The thresholds τₖₑₑₚ and τᵣₑₘₒᵥₑ are chosen consistent with this alternative.

| | |
|---|---|
| double ObjectPresentB( Image I, Object g, SceneModel G) { | (31) |

ImageRegion I_{g} = Proj(g, g+G);
// Compute p_{with}, the value of the objective function with g in the scene model
ImageRegion D_{w} = Unassociated(I, g+G);
SceneModel G_{new} = ModelNewObjecls(D_{w}, g+G, G⁻);
double p_{with} = P(I_{g} | g+G+G_{new}) P( Keep(g) | G⁻);
// Compute pₐₗₜ, the probability of an alternative explanation for g's image data.
int nData = the number of data items in I_{g}
double p_{E} = expected value of the error model for a region of nData items;
double pₐₗₜ = p_{E} * P(Remove(g) | G⁻)
// Compare
double φ = p_{with} / (p_{with} + pₐₗₜ);
if (φ ≧ τₖₑₑₚ ) return 1;
if (φ < τᵣₑₘₒᵥₑ ) return 0;
return 0.5;

}

Another approach to testing whether an object should be kept is employed by ObjectPresentC. It is based on comparing the number of data where the data error exceeds the threshold for data association, with an expected number based on the error model. Let κₖₑₑₚ and κᵣₑₘₒᵥₑ be thresholds for keep and remove, where 0≦κₖₑₑₚ≦κᵣₑₘₒᵥₑ. The two thresholds are expressed in units of standard deviation. The variables Σ, τ_{A} and x are as defined in ValidModel above.

| | |
|---|---|
| double ObjectPresentC( Image I, Object g, SceneModel G) { | (32) |

double n = 0; double nErrors = 0;
ImageRegion D_{w} = Unassociated(I, g+G);
SceneModel G_{new} = ModelNewObjects(D_{w}, g+G, G⁻);
forall Datum r ∈ Proj(g, g+G+G_{new}) {

| n++; | // Tally the number of data items |
|---|---|
| Vector e = DataError(r, I, G); | |
| if ( e^{T} * Σ⁻¹ * e > (τ_{A})² ) nErrors++; | // Tally the number of errors |

}
double nKeep = n*x + κₖₑₑₚ * (n*x*(1−x))^{1/2};
if ( nErrors < nKeep) return 1;
double nReject = n*x + κᵣₑₘₒᵥₑ * (n*x*(1−x))^{1/2};
if ( nErrors > nReject) return 0;
return 0.5;

}

For Gaussians or contaminated Gaussians, values of κₖₑₑₚ=κᵣₑₘₒᵥₑ=4 or 5 are typically effective. As κₖₑₑₚ is decreased or κᵣₑₘₒᵥₑ increased, a band of indeterminacy is created, for which both alternatives are considered by the calling function. Large bands of indeterminacy are appropriate when the sensor noise is large relative to the changes to be detected.

### Data Error

In the first embodiment, the difference between the value of the image datum at r and the corresponding value of the scene model is computed by equation (14) as

DataError(r,I,G)=ImageValue(r,I)−ModelValue(r,G)

In alternative embodiments, the difference can be computed in other ways. For example, if q is a pixel with a depth value, then q can be treated as a point in 3-space. The data error can be computed as the distance from q to the closest visible surface in G. When range data is computed with stereo, there may be an unusually high range error on highly slanted surfaces. The use of distance to surface is more tolerant of these errors than using only the difference along the z-dimension.

### P(I_{g}|G)

In the first embodiment, the probability of Iₐ given G is computed according to equation (17), under the assumption that the pixels are independent. In other embodiments, this probability may be computed in other ways.

One alternative way is to take into account the types of non-independence typically found in images. For example, a pixel with a very large error value is typically due to a systematic error, e.g. specular reflection, which causes the image to differ from its normal appearance. For such pixels, it is likely that adjacent pixels also have a very large error value. The computation of the probability P(I_{g}|G) can adjusted to account for this dependency.

Another alternative is to scale the product of the pₑ(DataError(r, I, G)) factors so that P(I_{g}|G) does not depend on the number of pixels and hence is relatively invariant to the resolution at which the image is acquired. One way to perform such scaling is to compute P(I_{g}|G) as

P(I_{g}|G)=(Π_{r∈I}_{_{g}}₎pₑDataError(r,I,G)))^{1/n} (33)

where n is the number of pixels in I_{g}.

### Associated and Unassociated Data

In the first embodiment, an image datum is associated with an object if the error between the datum and object scaled by the covariance matrix is less than a threshold. In alternative embodiments, data association can be computed in other ways. For example, the probability model for data errors, pₑ(.), could be used. Define the predicate IsAssociatedDatum2(r, I, g), meaning that datum r in image I is associated with object g, as

IsAssociatedDatum2(r,I,g)=pₑ(DataError(r,I,{g}))≦ω (34)

where ω is a threshold for data association based on probability. Associated and Unassociated are then based on IsAssociated2.

### Features as Data

The first embodiment uses pixels as the data for the purposes of data association, for computing P(I_{g}|G), as an argument to ModelNewObjects, etc. Depending on the object modeler, the pixels may be used directly to construct new objects or features may be computed from the pixels and the features used to construct new objects.

In alternative embodiments, the data may be features rather than pixels or the data may be features in addition to pixels. In such embodiments, the image is processed to detect image features; call these {f_{image}}. The 3D scene model G is processed to detect the model features that would be visible from the relevant observer; let {f_{model}} be the set of model features.

In embodiments where the data includes features, DataError(r, I, G), is computed on a feature by computing the difference between an image feature f_{image} at location r to a model feature f_{model} at r or a nearby location. The set of nearby locations thus considered is based on the variation in feature location for the specific feature detection method. Various distance measures may be used for the purpose of computing DataError(.). Among these distance measures are the Euclidean distance, the chamfer distance, the shuffle distance, the Bhattacharyya distance, and others. The function ObjectError(g, I, G) is computed over features as the set {DataError(r, I, G)|r∈I_{g}}, where r∈I_{g} is the features whose location is in I_{g}=Proj(g, G).

Data association is computed over features. For example, the image feature f_{image} at location r is associated with g if r∈Proj(g, {g}) and the DataError(r, I, {g}) meets the criteria for data association, e.g. the scaled value is less than some threshold. Similarly, when computing P(I_{g}|G), the quantification is over the features of g in the image region I_{g}; also, ModelNewObjects takes as an argument a set of features; also, ValidModel operates on features.

### The Object Modeler

As described above, various techniques may be used for object modeling. Many of these techniques can be improved by using occlusion ordering as follows: Let Dᵤ be the unassociated data. Initialize the set of new objects G_{N}=Ø.

The standard object modeler is surrounded by an iterative loop that operates as follows.
[1] Compute a trial set of new objects using the standard object modeler and call this G_{T}.
[2] Let g₁ be the first object in G_{T} in occlusion order (or MutOcc(g₁) if g₁ is part of a sequence of mutual occluders). Only g₁ need be correct, the others, G_{T}[2:n], may have errors.
[3] Add g₁ to G_{N}, remove the data associated with g₁ from Dᵤ.
[4] Repeat, starting with [1], until no additional objects can be produced by the standard object modeler from the unassociated data it is given.
By operating in this way, the object modeler can benefit from occlusion order, i.e. that occluding objects have been properly accounted for when computing each new object.

Also, many of the techniques used for object modeling can be improved by using the model of scene changes in addition to the unassociated data. Consider the objective function of equation (7). A new object g should be consistent with the image data, as described by the data factor P(I_{g}|G⁺), and should also be consistent with likely changes to the scene model, as described by the scene change factor P(Add(g)|G⁻). A suitable choice for a new object g maximizes the product of these two factors.

### Support and Contact Relations

In the first embodiment, objects are constrained to be non-intersecting. In alternative embodiments, additional constraints may be imposed. Among these is the constraint that every object has one or objects to restrain it from the force of gravity, e.g. one or more supports. Other embodiments may use other physical properties such as surface friction to compute support relationships.

In other embodiments, the constraints may be relaxed. For example, other embodiments may maintain information about the material properties of objects and allow objects to deform under contact forces.

### Adjust Existing Object

In the first embodiment, an object in the prior scene model G⁻ is either kept, moved or removed. In alternative embodiments, an object may be kept with an adjusted pose, as described in U.S. Patent Application No. 20100085358, filed Oct. 8, 2008, entitled “System and Method for Constructing a 3D Scene Model from an Image.”

### Multiple Observers

An embodiment has been described above in the context of a single sensor system with a single observer γ. However, some embodiments may make use of multiple sensor systems, each with an observer, so that in general there is a set of observers {γᵢ}. There are multiple images obtained at the same time, corresponding to the same physical scene. Each image datum is associated with a specific observer. For each observer γ, synthetic rendering is used to compute how the object g would appear to that observer; hence, each object datum is associated with a specific observer. Data association and other similar computations are carried out on data from the same observer.

### Moving Observers

Some embodiments may make use of one or more sensor systems that move over time, so that in general there is a time-varying set of observer descriptions {γᵢ}. In this case, the position of an observer may be provided by external sensors such as joint encoders, odometry or GPS. Alternatively, the pose of an observer may be computed from the images themselves by comparing with prior images or the prior scene model. Alternatively, the position of an observer may be computed by some combination thereof.

Dividing the Image into Regions

In alternative embodiments, processing can be optimized by separating the image into disjoint regions and operating on each region separately or in parallel. Operating on each region separately reduces the combinatorial complexity associated with the number of objects. Additionally, operating on each region in parallel allows the effective use of multiple processors.

As an example of when this separation may be carried out, the background object can be used for separation. Regions of the image that are separated by the background object are independent and the posterior scene model for each region can be computed independently of other such regions.

### Implementation of Procedural Steps

The procedural steps of several embodiments have been described above. These steps may be implemented in a variety of programming languages, such as C++, C, Java, Fortran, or any other general-purpose programming language. These implementations may be compiled into the machine language of a particular computer or they may be interpreted. They may also be implemented in the assembly language or the machine language of a particular computer.

The method may be implemented on a computer that executes program instructions stored on a computer-readable medium.

The procedural steps may also be implemented in either a general-purpose computer or on specialized programmable processors. Examples of such specialized hardware include digital signal processors (DSPs), graphics processors (GPUs), media processors, and streaming processors.

The procedural steps may also be implemented in specialized processors designed for this task. In particular, integrated circuits may be used. Examples of integrated circuit technologies that may be used include Field Programmable Gate Arrays (FPGAs), gate arrays, standard cell, and full custom.

Implementations using any of the methods described in this application may carry out some of the procedural steps in parallel rather than serially.

### Application to Robotic Manipulation

The embodiments have been described as producing a 3D object model. Such a 3D object model can be used in the context of an autonomous robotic manipulator to compute a trajectory that avoids objects when the intention is to move in free space and to compute contact points for grasping and other manipulation when that is the intention.

### Other Applications

The invention has been described partially in the context of robotic manipulation.

The invention is not limited to this one application, but may also be applied to other applications. It will be recognized that this list is intended as illustrative rather than limiting and the invention can be utilized for varied purposes.

One such application is robotic surgery. In this case, the goal might be scene interpretation in order to determine tool safety margins, or to display preoperative information registered to the appropriate portion of the anatomy. Object models would come from an atlas of models for organs, and recognition would make use of appearance information and fitting through deformable registration.

Another application is surveillance. The system would be provided with a catalog of expected changes, and would be used to detect deviations from what is expected. For example, such a system could be used to monitor a home, an office, or public places.

### CONCLUSION, RAMIFICATIONS, AND SCOPE

An embodiment disclosed herein provides a method for constructing a 3D scene model.

The described embodiment also provides a system for constructing a 3D scene model, comprising one or more computers or other computational devices configured to perform the steps of the various methods. The system may also include one or more cameras for obtaining an image of the scene, and one or more memories or other means of storing data for holding the prior 3D scene model and/or the constructed 3D scene model.

Another embodiment also provides a computer-readable medium having embodied thereon program instructions for performing the steps of the various methods described herein.

In the foregoing specification, the present invention is described with reference to specific embodiments thereof. Those skilled in the art will recognize that the present invention is not limited thereto but may readily be implemented using steps or configurations other than those described in the embodiments above, or in conjunction with steps or systems other than the embodiments described above. Various features and aspects of the above-described present invention may be used individually or jointly. Further, the present invention can be utilized in any number of environments and applications beyond those described herein without departing from the broader spirit and scope of the specification. The specification and drawings are, accordingly, to be regarded as illustrative rather than restrictive. These and other variations upon the embodiments are intended to be covered by the present invention, which is limited only by the appended claims.

What is claimed is:

1. A method for computing one or more 3D scene models comprising 3D objects and representing a scene, based upon a prior 3D scene model, the method comprising the steps of:
(a) acquiring an image of the scene;
(b) initializing the set of 3D scene models to the prior 3D scene model; and
(c) modifying the set of 3D scene models to be consistent with the image, by:
(i) comparing data of the image with objects of the 3D scene model, resulting in differences between the value of the image data and the corresponding value of the 3D scene model, in associated data corresponding to objects in the 3D scene model, and in unassociated data not corresponding to objects in the 3D scene model;
(ii) using the results of the comparison to detect objects that are inconsistent with the image and removing the inconsistent objects from the 3D scene models; and
(iii) using the unassociated data to compute new objects that are not in the prior 3D scene model and adding the new objects to the 3D scene models.

2. The method of claim 1, wherein using the results of the comparison to detect objects inconsistent with the image further comprises finding objects for which there is no associated image data and removing such objects.

3. The method of claim 1, wherein using the results of the comparison to detect objects inconsistent with the image further comprises detecting inconsistent objects of the prior 3D scene model in occlusion order.

4. The method of claim 1, wherein using the results of the comparison to detect objects inconsistent with the image further comprises determining that a first object is inconsistent by computing new objects that are not in the prior 3D scene model from unassociated data, adding the new objects to the 3D scene model with the first object, and evaluating the likelihood of the 3D scene model with the first object and new objects.

5. The method of claim 1, wherein using the results of the comparison to detect objects inconsistent with the image further comprises determining that an object is inconsistent by comparing a probability of the 3D scene model where the object is present against a probability of the 3D scene model where the object is absent.

6. The method of claim 5, wherein comparing a probability of the 3D scene model where the object is present against a probability of the 3D scene model where the object is absent, further comprises computing new objects that are not in the prior 3D scene model from unassociated data and adding the new objects to the 3D scene models being compared.

7. The method of claim 5, wherein the probability of a 3D scene model includes a factor representing the probability of scene changes from the prior 3D scene model.

8. The method of claim 1, wherein using the results of the comparison to detect objects inconsistent with the image further comprises constructing new 3D scene models where there is uncertainty as to whether an object is inconsistent and adding these new 3D scene models to the set of 3D scene models being modified to be to be consistent with the image.

9. The method of claim 1, wherein using the unassociated data to compute new objects that are not in the prior 3D scene model and adding the new objects to the 3D scene models is performed at least once, after all objects that are inconsistent with the image have been detected and removed from the 3D scene models.

10. The method of claim 1, wherein using the unassociated data to compute new objects that are not in the prior 3D scene model uses occlusion order when computing new objects.

11. The method of claim 10, wherein using occlusion order when computing new objects further comprises initializing the new objects to the empty set and:
(a) computing trial new objects from the unassociated data;
(b) sorting the trial new objects in occlusion order;
(c) adding the first trial object and any mutual occluders of the first trial object to the set of new objects; and
(d) removing, from the unassociated data, the data associated with the first trial object and its mutual occluders.

12. The method of claim 1, wherein modifying the 3D scene models to be consistent with the image further comprises identifying objects that have been moved.

13. The method of 12, wherein identifying objects that have been moved further comprises considering each new object and each removed object, determining the removed object, if any, that is the best replacement for the new object and substituting the removed object for the new object.

14. The method of claim 1, further comprising computing a probability of each 3D scene model in the set of 3D scene models and returning one or more 3D scene models with high probability.

15. The method of claim 14, wherein the probability of a 3D scene model includes a factor representing the probability of scene changes from the prior 3D scene model.

16. The method of claim 1, wherein the data is pixels and the values are range values.

17. A method for computing one or more 3D scene models comprising 3D objects and representing a scene, based upon a prior 3D scene model, and a model of scene changes, the method comprising:
(a) acquiring an image of the scene;
(b) initializing the set of 3D scene models to the prior 3D scene model; and
(c) modifying the set of 3D scene models to be consistent with the image and the model of scene changes, by:
(i) comparing data of the image with objects of the 3D scene model, resulting in differences between the value of the image data and the corresponding value of the 3D scene model;
(ii) using the differences and the model of scene changes to detect objects that are inconsistent with the image and the model of scene changes and removing the inconsistent objects from the 3D scene models; and
(iii) using the differences to compute new objects that are not in the prior 3D scene model and adding the new objects to the 3D scene models.

18. The method of claim 17, wherein detecting objects that are inconsistent with the image and the model of scene changes further comprises detecting inconsistent objects of the prior 3D scene model in occlusion order.

19. The method of claim 17, wherein detecting objects that are inconsistent with the image and the model of scene changes further comprises determining that a first object is inconsistent by computing new objects that are not in the prior 3D scene model from image data for which differences are large, adding the new objects to the 3D scene model, and comparing a probability the 3D scene model where the first object is present against a probability of the 3D scene model where the first object is absent.

20. The method of claim 19, wherein the probability of a 3D scene model includes a factor representing the probability of scene changes from the prior 3D scene model.

21. The method of claim 17, wherein using the unassociated data to compute new objects that are not in the prior 3D scene model and adding the new objects to the 3D scene models is performed at least once, after all objects that are inconsistent have been detected and removed from the 3D scene models.

22. A computer readable storage medium having embodied thereon instructions for causing a computing device to execute a method for computing one or more 3D scene models comprising 3D objects and representing a scene, based upon a prior 3D scene model, the method comprising:
(a) acquiring an image of the scene;
(b) initializing the set of 3D scene models to the prior 3D scene model; and
(c) modifying the set of 3D scene models to be consistent with the image, by:
(i) comparing data of the image with objects of the 3D scene model, resulting in differences between the value of the image data and the corresponding value of the 3D scene model, in associated data corresponding to objects in the 3D scene model, and in unassociated data not corresponding to objects in the 3D scene model;
(ii) using the results of the comparison to detect objects that are inconsistent with the image and removing the inconsistent objects from the 3D scene models; and
(iii) using the unassociated data to compute new objects that are not in the prior 3D scene model and adding the new objects to the 3D scene models.
